(19) United States
(12) Patent Application Publication
(10) Pub. No.: US 2022/0291821 A1
(43) Pub. Date: Sep. 15, 2022

(54) ELECTRONIC DEVICE AND CONTROL METHOD

(71) Applicant: ASUSTeK COMPUTER INC., TAIPEI (TW)

(72) Inventors: Yun-Ju CHEN, TAIPEI (TW); Chen-Yu HSU, TAIPEI (TW); Chih-Hsien YANG, TAIPEI (TW); I-Hsi WU, TAIPEI (TW); Hsin-Yi PU, TAIPEI (TW)

(21) Appl. No.: 17/686,508

(22) Filed: Mar. 4, 2022

(30) Foreign Application Priority Data
Mar. 15, 2021 (TW) 110109212

(51) Int. Cl. G06F 3/04847; G06F 3/0485; G06F 3/0488

(52) U.S. Cl. CPC G06F 3/04847; G06F 3/0485; G06F 3/0488

(57) ABSTRACT

The disclosure provides a control method, applicable to an electronic device. The control method includes: detecting a sliding operation from a first position to a second position on a touch screen of the electronic device, where the first position is an edge area of the touch screen and the second position is a position in which the sliding operation stops; calculating an angle of the sliding operation based on the first position and the second position; and comparing the angle with a threshold to determine whether to activate a one-handed operation mode of the electronic device.

### CROSS-REFERENCE TO RELATED APPLICATION

This application claims the priority benefit of Taiwan application serial No. 110109212, filed on Mar. 15, 2021. The entirety of the above-mentioned patent application is hereby incorporated by reference herein and made a part of specification.

### BACKGROUND OF THE INVENTION

### Field of the Invention

The disclosure relates to an electronic device and a method thereof, and in particular, to an electronic device and a control method.

### Description of the Related Art

The existing method for a one-handed operation is to activate the one-handed operation mode by quickly tapping the home screen key (such as a HOME key) of the mobile device. However, such a method causes the wrong activation of the one-handed mode by mistakenly touching the home screen key, resulting in a considerably inconvenient use.

### BRIEF SUMMARY OF THE INVENTION

According to the first aspect of the disclosure, a control method applied to an electronic device is provided, the control method including: detecting a sliding operation from a first position to a second position on a touch screen of the electronic device, where the first position is an edge area of the touch screen and the second position is a position in which the sliding operation stops; calculating an angle of the sliding operation based on the first position and the second position; and comparing the angle with a threshold to determine whether to activate a one-handed operation mode of the electronic device.

According to the second aspect of the disclosure, an electronic device is provided. The electronic device includes a touch screen and a processor. The touch screen is configured to detect a sliding operation from a first position to a second position, where the first position is an edge area of the touch screen and the second position is a position in which the sliding operation stops. The processor is electrically coupled to the touch screen, where the processor is configured to: calculate the angle of the sliding operation based on the first position and the second position; and compare the angle with a threshold to determine whether to activate a one-handed operation mode of the electronic device.

### BRIEF DESCRIPTION OF THE DRAWINGS

When the following detailed description is read with reference to the accompanying drawings, the aspect of the disclosure is better understood. It should be noted that, in accordance with the practical requirements of the description, each feature in the drawings is not necessarily drawn to scale. In fact, for the purpose of clarity, the size of the each feature may be increased or decreased arbitrarily.

FIG. 1 illustrates a schematic diagram of a sliding operation of an electronic device according to some embodiments of the disclosure.

FIG. 2 illustrates a block diagram of electronic components of an electronic device according to some embodiments of the disclosure.

FIG. 3 illustrates a flowchart of a control method according to some embodiments of the disclosure.

FIG. 4 illustrates a schematic diagram of a touch screen of an electronic device according to some embodiments of the disclosure.

FIG. 5 illustrates a schematic diagram of an original display area of an electronic device according to some embodiments of the disclosure.

FIG. 6 illustrates a schematic diagram of an interface display area under a one-handed operation of an electronic device according to some embodiments of the disclosure.

### DETAILED DESCRIPTION OF THE EMBODIMENTS

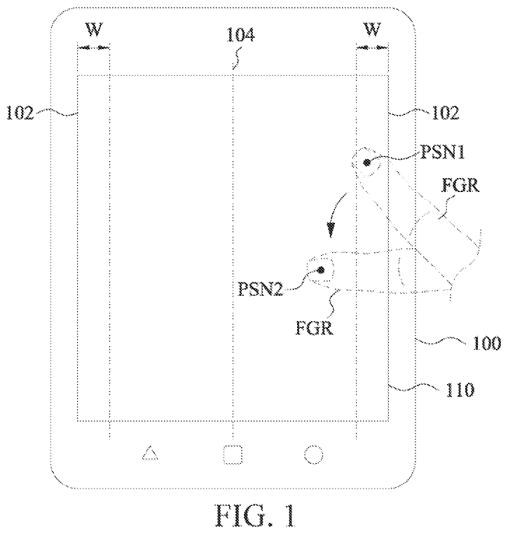

Referring to FIG. 1, an electronic device 100 includes a touch screen 110. A user performs any touch operation on the touch screen 110 with a finger. As shown in FIG. 1, in an embodiment, a thumb FGR of the user first touches a first position PSN1 on an edge area W of the touch screen 110, and then slides the thumb FGR to a second position PSN2 on the touch screen 110 to trigger a one-handed operation mode.

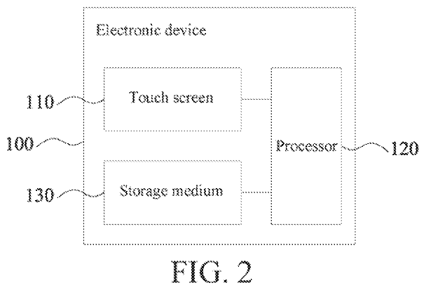

FIG. 2 illustrates a block diagram of electronic components of an electronic device 100 according to some embodiments of the disclosure. As shown in FIG. 2, the electronic device 100 includes a touch screen 110, a processor 120, and a storage medium 130. The touch screen 110 and the storage medium 130 are electrically coupled to the processor 120. The touch screen 110 is configured to detect any touch operation made with the finger of the user on the touch screen 110, and generate a corresponding operation signal to be transmitted to the processor 120. The processor 120 will perform corresponding calculation and determination according to the operation signal received from the touch screen 110. The storage medium 130 is configured to store a plurality of instructions and a threshold that is associated with the calculation of the operation signal, which will be described in detail later.

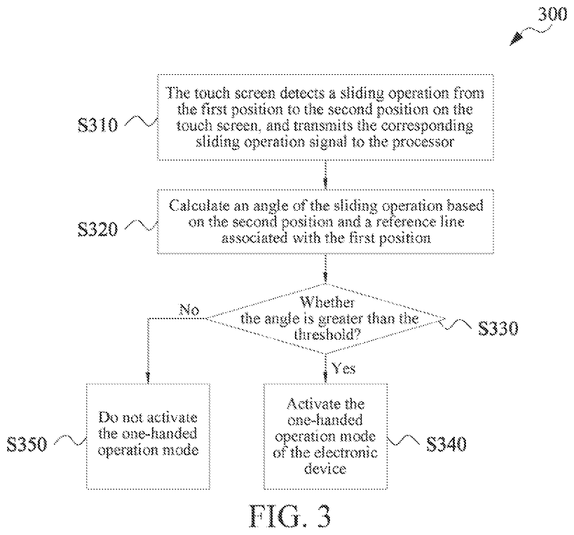

For ease of illustrating the activation of the one-handed operation mode on the electronic device 100, reference is made to FIG. 1 and FIG. 3 together. FIG. 3 illustrates a flowchart of a control method 300 according to some embodiments of the disclosure. The control method 300 is applied to and performed by the electronic device 100 in FIG. 2.

In step S310, the touch screen 110 detects a sliding operation from the first position PSN1 to the second position PSN2 on the touch screen 110, and transmits the corresponding sliding operation signal to the processor 120. The first position PSN1 is in an edge area W of the touch screen 110 and the second position PSN2 is a position in which the sliding operation stops. In an embodiment, the edge area W extends from a border 102 to a center 104 of the touch screen 110 by a screen width of about 20 pixels to 60 pixels.

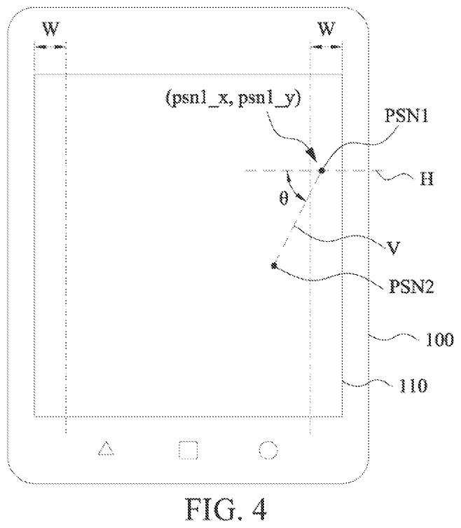

Referring to FIG. 4, a touch screen 110 detects a sliding operation from a first position PSN1 to a second position PSN2. In an embodiment, when the edge area W of the touch screen 110 detects a touch operation, it will be considered that a user intends to trigger a one-handed operation mode. In an embodiment, it is determined that the sliding operation stops when the touch screen 110 determines that a finger is in touch with a position for a preset period of time, such as 400 milliseconds. In this embodiment, when a thumb touches a second position PSN2 for a preset period of time, the second position PSN2 is determined as a position in which the sliding operation stops.

Referring to FIG. 3 and FIG. 4, in step S320, an angle θ of the sliding operation is calculated based on the second position PSN2 and a reference line associated with the first position PSN1. In an embodiment, the first position PSN1 includes a reference line H orthogonal to the edge area W. In detail, the processor 120 will obtain the reference line H based on ay-coordinate of pixel coordinates of the first position PSN1. In an embodiment, if pixel coordinates of the first position PSN1 are (psn1_x, psn1_y), the reference line H is a function of Y=_{ypsn1_y}. In some embodiments, the reference line H is a virtual line parallel to an upper edge and/or a lower edge of the electronic device 100.

In an embodiment, from a first position PSN1 to a second position PSN2, there is an operation vector V. In detail, the processor 120 obtains the pixel coordinates of the first position PSN1 and the pixel coordinates of the second position PSN2, and then calculates the operation vector V for the sliding operation based on the two sets of pixel coordinates. Then, the processor 120 calculates the angle θ between the operation vector V and the reference line H.

In step S330, the processor 120 determines whether the angle θ is greater than a threshold.

In some embodiments, the threshold is 60°. It is worth mentioning that FIG. 4 illustrates an operation of sliding downward with a thumb. Alternatively, a user slides upward with a thumb, the angle θ is similarly calculated through the above steps S310 to S330, and whether the angle θ is greater than the threshold is determined.

In step S330, when it is determined that the angle θ between the operation vector V and the reference line H is greater than the threshold, step S340 is performed. In step S340, the one-handed operation mode of the electronic device 100 is activated. In step S330, when it is determined that the angle θ between the operation vector V and the reference line H is less than the threshold, step S350 is performed without activating the one-handed operation mode.

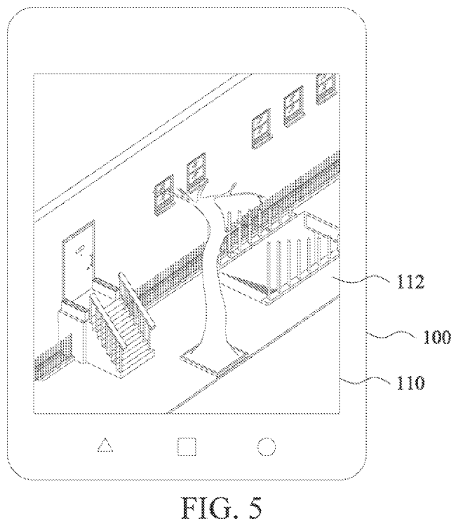

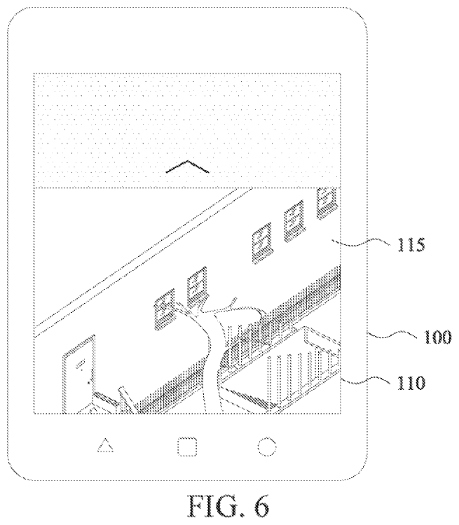

Referring to FIG. 5 and FIG. 6, in an embodiment, as shown in FIG. 5, an electronic device 100 displays a general operating interface on an original display area 112 of a touch screen 110. When the electronic device 100 operates in a one-handed operation mode, as shown in FIG. 6, the processor 120 will define an interface display area 115 on the touch screen 110. The interface display area 115 is smaller than the original display area 112 of the touch screen 110. Therefore, when the electronic device 100 operates in the one-handed operation mode, a display content originally displayed in the original display area 112 of the touch screen 110 will be scaled down and be displayed in the interface display area 115; or a display content originally displayed in the original display area 112 of the touch screen 110 will be moved or cropped to be displayed only in the interface display area 115. In an embodiment, the interface display area 115 is an area that is touched by a user holding the electronic device 100 with one hand (not limited to the left or right hand).

In some embodiments, the sliding operation triggering the one-handed operation mode is to slide upward or downward from the edge area W of the touch screen 110 and stay for a preset period of time.

In an embodiment, the processor 120 determines the range of the interface display area 115 on the touch screen 110 according to the first position PSN1.

In some other embodiments, when a user slides upward from a first position PSN1 (not shown in FIG. 6), the range of the interface display area 115 is a range from the first position PSN1 to the upper border of the touch screen 110. In this case, the interface display area 115 is the upper part within the range of the touch screen 110. In this way, the first position PSN1 of the sliding operation determines the size and position of the interface display area 115 in the one-handed operation mode.

In some embodiments, the electronic device 100 is implemented as, but is not limited to, a portable device, a mobile device, a tablet computer, a personal digital assistant (PDA), a wearable device, or a notebook computer. Any electronic device with a touch screen falls within the scope of the disclosure.

In some embodiments, the touch screen 110 is implemented as, but is not limited to, a capacitive device, an infrared device, a resistive device, or a surface acoustic wave (SAW) device, and is any type of touch screen that is currently known or is to be developed in future.

In some embodiments, the processor 120 is implemented as, but is not limited to, a central processing unit (CPU), a System on Chip (SoC), an application processor, an audio processor, a digital signal processor (DSP), or a processing chip or controller with a specific function.

In some embodiments, the storage medium 130 is implemented as, but is not limited to, a random access memory (RAM) or a non-volatile memory (such as a flash memory or a read only memory (ROM)), a hard disk drive (HDD), a solid state drive (SSD), or an optical storage.

In some embodiments, the control method in the disclosure alternatively stores a non-transitory computer-readable recording medium in the form of instructions. The non-transitory computer-readable recording medium stores a plurality of program codes. After the program codes are loaded into the processor 120 shown in FIG. 2, the processor 120 executes the program codes and performs the steps shown in FIG. 3. In an embodiment, the processor 120 detects the sliding operation on the touch screen 110 from the first position PSN1 to the second position PSN2, calculates the angle of the sliding operation based on the reference line between the second position and the first position, and determines whether to activate the one-handed operation mode of the electronic device by determining whether the angle is greater than the threshold.

In conclusion, the disclosure provides an electronic device and a control method thereof to provide an activation procedure for a one-handed operation mode of the electronic device, which allows the one-handed operation mode to be used considerably conveniently without a navigation key. In addition, the control method provided in the disclosure quickly activates the one-handed mode, is applicable to touch screens of various sizes, and further determines whether to activate the one-handed operation mode when detecting a touch signal of the user, which improves the accuracy of the activation of the one-handed operation mode, and avoids the problem of touching the screen or key by mistake.

The foregoing content summarizes the features of several embodiments, so that a person familiar with the art can better understand the aspect of the disclosure. Without departing from the spirit and scope of the disclosure, a person skilled in the art should know that the foregoing content may be readily used as a basis for designing or modifying into other variations in order to implement the same purpose of the embodiments described in the disclosure and/or achieve the same advantage. The foregoing content shall be construed as examples of the disclosure, and the scope of protection thereof shall be subject to the claims.

What is claimed is:

1. A control method, applicable to an electronic device, the control method comprising the following steps:
detecting a sliding operation from a first position to a second position on a touch screen of the electronic device, wherein the first position is an edge area of the touch screen and the second position is a position in which the sliding operation stops;
calculating an angle of the sliding operation based on the first position and the second position; and
comparing the angle with a threshold to determine whether to activate a one-handed operation mode of the electronic device.

2. The control method according to claim 1, wherein the step of calculating an angle of the sliding operation based on the first position and the second position further comprises:
calculating an operation vector between the first position and the second position when the sliding operation stops at the second position for a period of time;
calculating a reference line of the first position; and
calculating the number of degrees of the angle between the operation vector and the reference line, wherein the reference line is a virtual line parallel to an upper edge and/or a lower edge of the electronic device.

3. The control method according to claim 2, wherein the first position comprises the reference line orthogonal to the edge area.

4. The control method according to claim 1, wherein the step of comparing the angle with a threshold to determine whether to activate a one-handed operation mode of the electronic device further comprises:
activating the one-handed operation mode of the electronic device when the number of degrees of the angle is greater than the threshold.

5. The control method according to claim 1, further comprising:
determining a range of an interface display area of the one-handed operation mode on the touch screen based on the first position.

6. An electronic device, comprising:
a touch screen, configured to detect a sliding operation from a first position to a second position, wherein the first position is an edge area of the touch screen and the second position is a position in which the sliding operation stops; and
a processor, electrically coupled to the touch screen, wherein the processor is configured to:
calculate an angle of the sliding operation based on the first position and the second position; and
compare the angle with a threshold to determine whether to activate a one-handed operation mode of the electronic device.

7. The electronic device according to claim 6, wherein the processor is further configured to:
calculate an operation vector between the first position and the second position when the sliding operation stops at the second position for a period of time;
calculate a reference line of the first position; and
calculate the number of degrees of the angle between the operation vector and the reference line, wherein the reference line is a virtual line parallel to an upper edge and/or a lower edge of the electronic device.

8. The electronic device according to claim 7, wherein the first position comprises the reference line orthogonal to the edge area.

9. The electronic device according to claim 6, wherein the processor is further configured to:
activate the one-handed operation mode of the electronic device when the number of degrees of the angle is greater than the threshold.

10. The electronic device according to claim 6, wherein the processor is further configured to:
determine a range of an interface display area of the one-handed operation mode on the touch screen based on the first position.
